(19) United States
(12) Patent Application Publication
(10) Pub. No.: US 2008/0103961 A1
(43) Pub. Date: May 1, 2008

(54) Private Institutional Credit Derivative

(75) Inventors: Vipin Ramani, Charlotte, NC (US); Daniel Angres, Charlotte, NC (US); Glen Danziger, Charlotte, NC (US); Colin J. McClary, Elmhurst, IL (US); Stephen T. Monahan, Charlotte, NC (US); Arrington Hearn Mixon, Charlotte, NC (US); Charles L. Ruifrok, Chicago, IL (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA, Charlotte, NC (US)

(21) Appl. No.: 11/555,319

(22) Filed: Nov. 1, 2006

(51) Int. Cl. G06Q 40/00

(52) U.S. Cl. 705/38

(57) ABSTRACT

Systems and methods are disclosed for providing a credit derivative to protect against the credit risk associated with a private debt on an individual basis. A financial institution lending money to a private entity may desire a credit derivative product that allows the financial institution to protect against the risk of default by the private entity. Such a credit derivative product allows the financial institution to bifurcate the cash flow from the privately issued loan into a no-risk portion and a credit risk portion. Once an agreement for a credit derivative product is executed, the information for the derivative product may be recorded and maintained in the institution's bookkeeping system. In some instances, the agreement may include an early termination option for the protection buyer.

### FIELD OF THE INVENTION

Aspects of the disclosure relate to financial products and markets. More specifically, aspects of the disclosure relate to credit derivative products.

### BACKGROUND

The Bank for International Settlements estimates that the total outstanding notional amount in the over-the-counter (OTC) credit derivatives market is $298 trillion as of 2005. OTC derivative products differ from exchange-traded derivative products (e.g. exchange-traded futures contracts, exchange-traded options, etc.) in that OTC products are traded directly between two parties, called counterparties. Meanwhile, exchange-traded derivative products require an exchange to act as an intermediary to all transactions. The exchange serves as a guarantor of the derivative products.

Banks, as issuers of debt, incur substantial risk that their borrower may default on the debt. In the past, banks controlled risk exposure using a self-governance model. For example, a bank may limit the total amount of outstanding issued debt at any given time. In another example, a bank may control risk exposure on a pooled-basis by syndicating numerous debts into a multi-tiered facility. However, the bank, as the leading bank of a facility, is in some instances required to report information to the borrower. Thus, this creates additional overhead costs and inefficiencies for the bank.

Although credit derivative products may be used to manage exposure to credit risk, these derivative products are usually indexed to borrowers that have liquid public securities, such as publicly traded corporate bonds. Therefore, a need exists for a credit derivative product indexed to a commercial borrower that has utilized a syndicated bank facility, private placement notes, or other non-public debt instruments for its debt capital needs. Thus, there exists a need for an effective tool that lenders may use to hedge the exposure to such borrowers.

### BRIEF SUMMARY

Aspects of the present disclosure address one or more of the issues mentioned above by disclosing a system and method for providing a credit derivative product for a borrower that has a debt structure that lacks an active public market, such as a private placement note, etc. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In one embodiment in accordance with aspects of the disclosure, a method is illustrated for providing a credit derivative product to a counterparty. A financial institution may identify a named entity as a candidate for a reference entity of a credit derivative product. The reference entity has issued private debt that may be a possible candidate for a credit derivative product. The institution evaluates the proposed derivative product using predetermined criteria and determines terms for the agreement of the derivative product. In addition, the institution may determine whether executing the agreement violates certain compliance requirements. After satisfying these procedures, the agreement may be provided to a counterparty for execution. A second counterparty may also be obtained for execution of the agreement, in some embodiments. The counterparties may be provided with confirmation of the executed agreement. Finally, information relating to the executed agreement may be recorded in at least one bookkeeping system. In some embodiments, the information may be recorded in two bookkeeping systems.

In another embodiment in accordance with aspects of the disclosure, a type of credit derivative product called a credit default swap may be provided. In yet another embodiment, a credit derivate product may be provided using a computer-assisted system comprising a first, second, and third computer apparatus. The computer apparatuses may be human-operated and provide, among other things, a means for communicating during the process of creating and executing a credit derivative product, such as a credit default swap for a private debt structure.

### BRIEF DESCRIPTION OF THE DRAWINGS

The present disclosure is illustrated by way of example and not limited in the accompanying figures in which like reference numerals indicate similar elements and in which:

FIG. 1 shows an illustrative operating environment in accordance with aspects of the disclosure;

FIG. 2 shows an illustrative method for providing a credit derivative product in accordance with aspects of the disclosure;

FIG. 3 shows an illustrative method for providing a credit derivative product to two counterparties in accordance with aspects of the disclosure; and

FIG. 4 shows an illustrative method for providing a credit derivative product with an early termination option in accordance with aspects of the disclosure.

### DETAILED DESCRIPTION

In accordance with various aspects of the disclosure, systems and methods are illustrated for providing a credit derivative product to protect against the credit risk associated with a reference entity that has issued private debt on an individual basis. For example, given a market situation where there exists an oversupply of available funds and a general appetite for credit risk taking, a financial institution lending money to a private entity may desire a credit derivative that allows the financial institution to protect against the risk of default by the private entity. In some embodiments, such a credit derivative may allow the institution to bifurcate the cash flow from the privately issued loan into a no-risk portion and a credit risk portion. The cash flow from the credit risk portion is related to the credit risk associated with the borrowing entity.

An institution providing a credit derivative product in accordance with aspects of the disclosure may identify a named entity as a candidate for a reference entity of a credit derivative product. The institution may evaluate the marketability (e.g., demand, liquidity) and desirability of the credit derivative product using predetermined criteria. In addition, the institution may consider the compliance or lack thereof of the derivative product with policies and procedures. The institution may act as a counterparty or as an agent (e.g. broker) for the derivative product. Once the agreement for the derivative product is executed, the information for the derivative product may be recorded and maintained in the institution's bookkeeping system. Moreover, the institution is not required to disclose any information to the reference entity of the credit derivative product. Thus, reducing overhead costs.

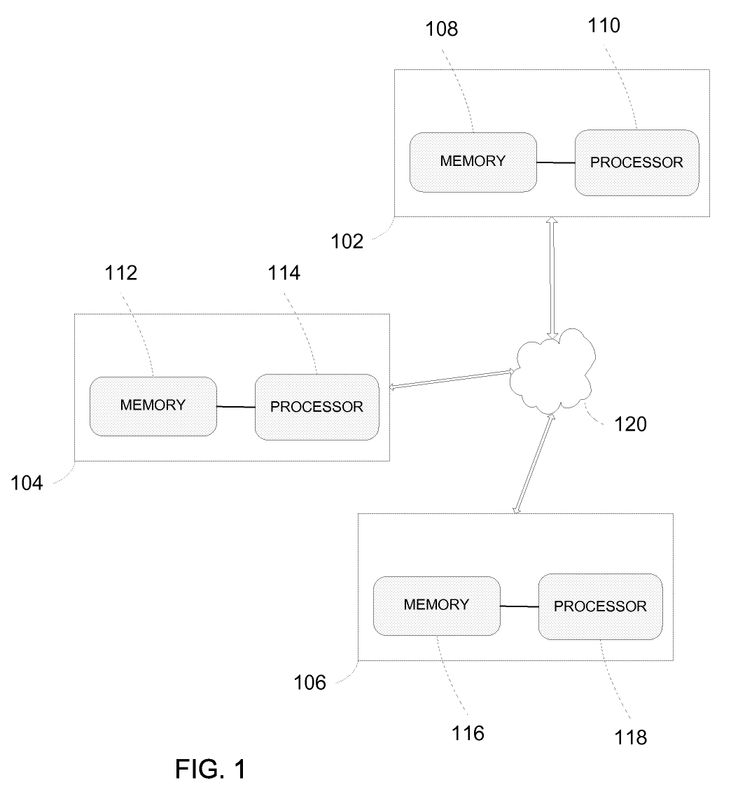

FIG. 1 illustrates an example of a suitable operating environment in which various aspects of the disclosure may be implemented. Computer apparatuses 102, 104, 106 comprising memories 108, 112, 116 and processors 110, 114, 118 are disclosed. The processors 110, 114, 118 may execute computer-executable instructions present in memory 108, 112, 116 such that, for example, a computer apparatus 102 may send and receive information to and from other computer apparatuses 104, 106 connected to the computer network 120. The computer apparatuses 102, 104, 106 may communicate (e.g., send and receive information) using electronic mail (e.g., Microsoft Outlook™, Lotus Notes, Yahoo! Mail, etc.) or other types of electronic communication (e.g., AOL instant messenger, Google chat, etc.). The computer apparatuses 102, 104, 106 may be a conventional computer system with non-volatile and/or volatile memory and a conventional Intel™ Pentium processor for executing the appropriate software. In another example, a computer apparatus 106 may comprise an electronic bookkeeping system for recording information relating to executed agreements for credit derivative products. The computer apparatus 106 may comprise computer-executable instructions that are executed by a processor 118 to, among other things, record information about the credit derivative transaction. Some examples of electronic bookkeeping systems include, but are not limited to, eBlotter, IRP, and Advantage.

For example, computer apparatuses 102, 104, 106 may be used by employees or other members of departments/groups in a financial institution to create and offer a credit derivative product. As is common with financial institutions, some departments or groups may be compartmentalized for confidentiality, fiduciary, and other reasons. Groups privy to material non-public information about a named entity may be precluded from participating in the providing of a credit derivative product involving that named entity. For at least that reason, a computer-assisted system, such as the one illustrated in FIG. 1, may have the added benefit of enhancing the efficiency and organization of communication channels between various groups and departments in a financial institution to ensure compliance with at least these requirements regarding insider's information.

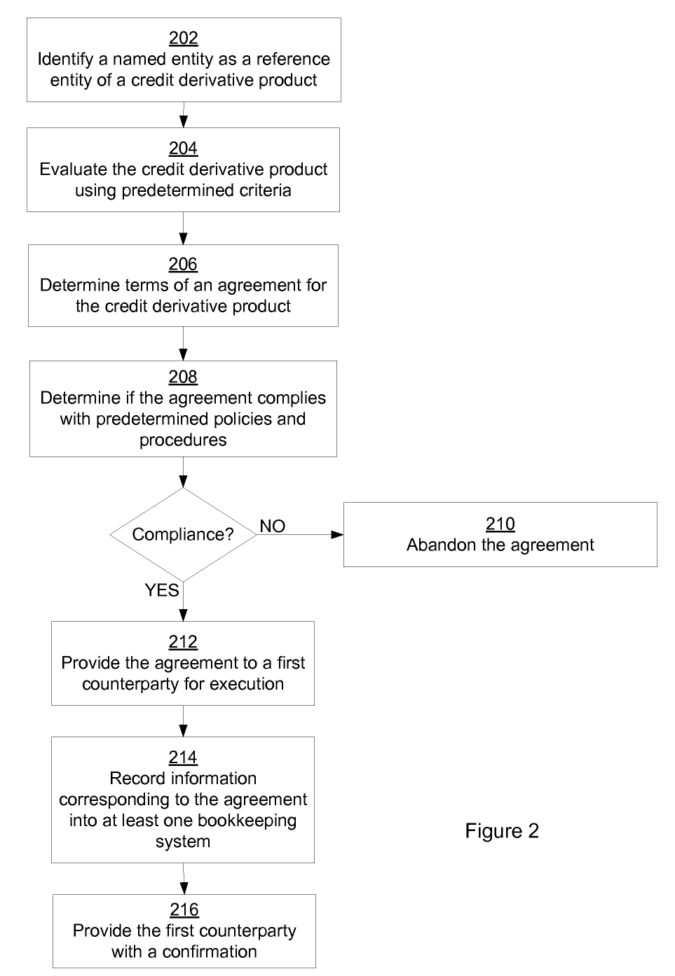

Referring to FIG. 2, a member of a group (e.g., global portfolio management) in a financial institution may identify (in step 202) a named entity as a reference entity of a credit derivative product. The named reference entity may have private debt that the member of the group believes may be desirable to offer as a reference obligation of a credit derivative product. For example, ABC Corporation may be a privately-held or public corporation with $100,000 of outstanding private debt issued by a multi-tiered syndicated bank facility. One or more of the banks that are a party to the syndicated bank facility may wish to purchase protection from the risk that ABC Corporation will default on the outstanding $100,000 loan. The member of the group may use a computer apparatus to send a proposal for a credit derivative product to another group. The proposal may contain the identity of a named entity (e.g., ABC Corporation) and the private debt of that named entity that the group wishes to offer as a reference obligation of a credit derivative product.

A member in another group (e.g., global portfolio strategy commercial innovation group) may receive the proposal for the credit derivative product. In one example, the group member receives the proposal using a computer apparatus 104. The group member may evaluate (in step 204) the proposed credit derivative product using predetermined criteria. For example, the group member may determine whether the named reference entity is illiquid (i.e., liquidity criteria). If a public credit derivatives market already exists for the named entity, the group member may conclude that the entity is not sufficiently illiquid. The group member may also consider the total notional limit currently allocated to the group and whether the proposed derivative product would exceed this limit. In addition, the group member may consider whether there is market interest in buying/selling a credit derivative product on the private debt of the named entity. For example, the group member may factor in whether investors have shown interest in the past. A group member may attempt to identify at least one potential counterparty for the credit derivative product to ensure that sufficient interest exists for the proposed derivative product. Furthermore, the group member may analyze performance of competitors of the named entity and industry spreads to evaluate the proposed derivative product. The group member may also consider spread information from prior private placements of the named entity. Tools such as credit models, optimization models, and others may be used in performing the analysis.

In step 206, the group member may determine the terms of an agreement for the credit derivative product. The agreement may be a legal contractual agreement drafted using some of the definitions and provisions contained in the 2003 International Swaps and Derivatives Association, Inc. (ISDA) Credit Derivative Definitions guide, which is incorporated by reference here. The group member may supplement the agreement with various values and information. For example, the terms of the agreement may comprise a definition of triggering credit events (e.g. bankruptcy, failure to pay, etc.), settlement terms (e.g., cash settlement, physical settlement), and confidentiality provision. Furthermore, the terms of agreement may include, but are not limited to, notional amount, spread, and recovery rate of the derivative product.

In one embodiment, the terms of the agreement may include an early termination option clause. The early termination option clause may be used to terminate the agreement for the credit derivative product if a referenced obligation has been terminated and not replaced or refinanced by the reference entity (e.g., a credit termination event). Upon the occurrence of a credit termination event, the protection buyer may have the option to terminate the credit derivative contract. A protectijn buyer includes a counterparty that is trying to transfer credit risk, and the protection seller includes the counterparty is trying to acquire credit risk. In another embodiment, a counterparty may optionally terminate the credit derivative contract in the event that the protection seller no longer has access to the reference entity's financial information. If a protection seller is no longer able to access the financial information of a reference entity and there is no way for the protection seller to obtain access to this information (e.g., the protection buyer is unable to provide such financial information to the protection seller nor transfer or sell a de minimis amount of a private loan or bond to the protection seller), then the protection buyer may be given a predetermined time period (e.g., within 30 days of the event) within which to terminate the derivative product agreement. In some embodiments an early termination fee may be applied if the agreement is terminated before a second predetermined time period (e.g., 2 years). At least one benefit of the early termination option clause is the enhanced liquidity offered upon the occurrence of an early termination event. As described in the example above, one example of an early termination event is the change in the status of a protection seller such that the protection seller is no longer legally entitled to the financial information of the reference entity.

In another embodiment, the group may estimate a value (e.g., market price) for the credit derivative product. Due to the illiquid nature of this credit derivative product, sometimes direct observable price discovery may not be possible. In one embodiment, the par credit spread and volatility assumptions may be approximated using comparable trades observed in the market and then input into a model. If the reference entities have recently issued or traded in the private markets, this information may be used to approximate the credit spread. In addition, comparable public companies with actively traded derivative products or bonds may be used to estimate a value for the derivative product. In some embodiments, the market price term of the agreement may be an estimated value or a recommended range for the appropriate member in the financial institution to take into consideration when negotiation for the execution of the agreement.

Before the agreement can be executed, the agreement may be provided to another group (e.g. control room group) to determine (in step 208) if the agreement complies with predetermined policies and procedures. Various members of the financial institution may be requested to complete compliance forms and/or affidavits swearing that such members are not in possession of any private agent-only information about the reference entity. Private agent-only information is information that is made available by or on behalf of a company on a confidential basis to an agent, arranger, or lead bank for a loan that the company has deliberately not made available to all of the members or potential members of a particular lending syndicate. Private agent-only information may also include information that is provided by a company in connection with a financial institution providing financial, mergers and acquisition, or other advisory services to a company, and may include material non-public information. The predetermined policies and procedures may include external governmental regulations, rules, or laws and/or guidelines created internally by the institution. For example, the group may check to ensure that the reference entity is not on a watch list or restricted list of entities. If the group determines that the agreement does not comply with predetermined policies and procedures (e.g., the entity is on a watch/restricted list, a group member has private agent-only information, etc.), then the agreement for the proposed derivative product may be abandoned (in step 210) and the appropriate groups may be notified that the proposed product will not be provided by the institution. In an alternative embodiment, no compliance requirements or lesser compliance requirements may be in place.

Once compliance requirements, if any exist, have been fulfilled, a member of the appropriate group in the financial institution may use a computer apparatus 104 to send an acceptance of the proposal for the credit derivative product. Upon notification of approval, the financial institution may provide (in step 212) the agreement to a first counterparty for execution. The counterparty, in some embodiments, must have an ISDA master agreement in place with the financial institution before the agreement may be executed. In other embodiments, the financial institution may impose counterparty guideline limits, such as margin requirements, deposit requirements, etc., before the agreement may be executed.

The terms of the agreement provided to the counterparty may include those terms that were earlier determined (in step 206). In some embodiments, the terms may be adjusted, eliminated, or added during negotiation with the counterparty. For example, the price of the credit derivative may be adjusted before execution of the agreement. In addition, at least some terms that may be found in the agreement include, but are not limited to, counterparty names, trade date (i.e., date of execution), effective date, maturity date, notional value, reference entity, reference obligation, and recovery rate.

The counterparty in the agreement for the credit derivative product may be a member of a syndicate for the private debt of the reference entity. As explained earlier, the counterparty may use the credit derivative product, in accordance with aspects of the disclosure, to minimize the risk of default by the reference entity or to obtain additional credit exposure to the reference entity. As a member of the group of lenders lending money to the named entity, the counterparty may be particularly interested in this credit derivative product. In another example, the counterparty may be an insurance provider or an asset fund manager. Some insurance providers have developed advanced credit risk models and may have a greater appetite for credit risk than other entities. In addition, the counterparty(s) to the agreement may be provided (in step 216) with a confirmation of the executed agreement. The confirmation may be in the form of an electronic mail containing the terms of the executed agreement that confirms the execution of the legal agreement.

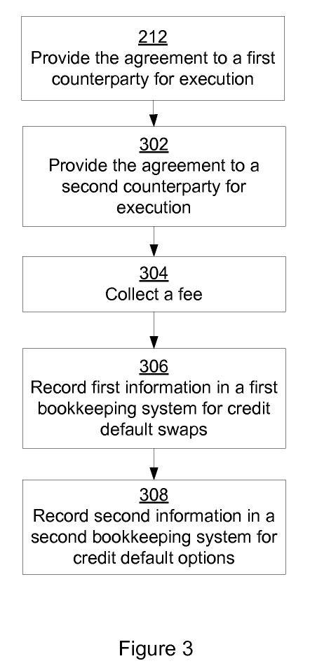

Once executed, the information corresponding to the terms of the executed agreement for the credit derivative product is recorded (in step 214) into at least one bookkeeping system. In one embodiment, a computer apparatus 106 comprises an electronic bookkeeping system for recording the information (e.g., maturity date, settlement type, recovery rate, counterparty names, etc.) in a memory. The memory may be memory 116 or may be an external non-volatile memory for storing sufficient capacity to hold the voluminous information corresponding to credit derivative products. Furthermore, in some embodiments in accordance with aspects of the disclosure, the financial institution may record the information into two bookkeeping systems. Referring to FIG. 3, the institution may record (in step 306) information of the executed transaction in a first bookkeeping system as if the agreement corresponds to a credit default swap. The institution may also record (in step 308) information of the executed transaction in a second bookkeeping system as if the agreement corresponds to a credit default option (i.e., swaption). The information recorded in the first bookkeeping system and the second bookkeeping system need not necessarily be the same. For example, the early termination option clause in the agreement for the a credit default swap product creates, in effect, a short credit default swap with an embedded offsetting option to sell credit protection. The bookkeeping may be bifurcated for bookkeeping purposes, into a credit default swap and an option on the same credit default swap. One will appreciate that although the model may be used for European style options as well as Bermuda style options (by taking the maximum value of all underlying European style options in a conservative valuation approach).

Referring to FIG. 3, in some embodiments, the financial institution may act as an agent (e.g. broker) to the agreement and collect (in step 304) a fee (e.g., a commission, a fixed fee, etc.) for its services. In such an embodiment, the financial institution may provide the agreement to a first counterparty (in step 212) and a second counterparty (in step 302) for execution.

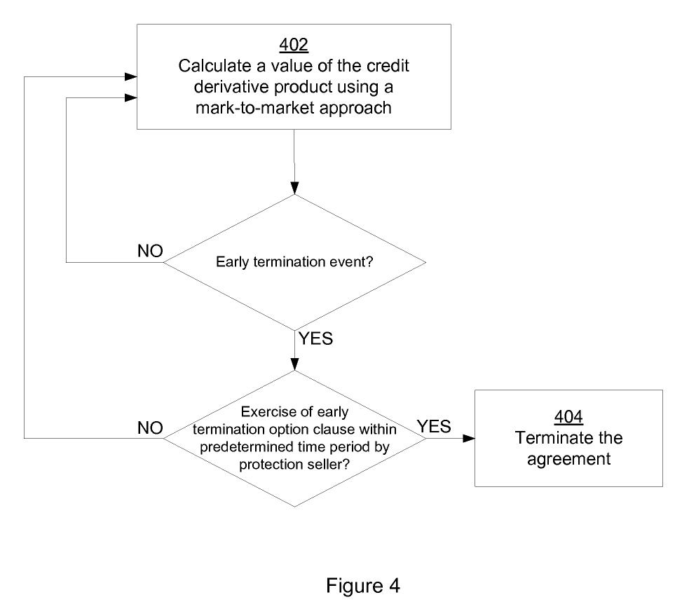

Referring to FIG. 4, the financial institution may calculate (in step 402) a value of the credit derivative product for the counterparties. The financial institution may consider credit spread information, volatility assumptions, comparables, industry guidelines, and other information in calculating a market value for the derivative product. The financial institution may use a mark-to-market approach to adjust (in step 402) the value of the credit derivative product. The mark-to-market adjustments may be performed, in some embodiments, on a monthly basis. In other embodiments, the mark-to-market readjustment may be performed twice a month or at any other interval of time. In still other embodiments, the frequency of the mark-to-market readjustments may be based on market conditions.

One example of a credit derivative product is a credit default swap with a fixed recovery rate and cash settlement. A settlement of a credit default swap is triggered upon: (1) the occurrence of a termination event, or (2) the reaching of the maturity date. A credit termination event may, in one embodiment, occur if all outstanding obligations under the reference obligation have been paid in full and all liens securing obligations under the reference obligation have been released. The ISDA, as explained earlier, also defines numerous triggered credit events (e.g., bankruptcy, failure to pay, etc.) that may serve as credit termination events. In addition, a credit derivative product, such as a credit default swap, in accordance with aspects of the disclosure may be terminated (in step 404) upon the occurrence of an early termination event if the protection buyer exercises his/her early termination option within a predetermined time period. Upon exercise of the early termination option, the counterparties do not settle the derivative agreement. Instead, assuming no early termination fee is due, no exchange between the counterparties occurs (e.g., no settlement occurs) at termination. In another embodiment, if the early termination option is exercised, the protection buyer and protection seller settle the accrued premium on the derivative product.

Although an illustrative embodiment in accordance with aspects of the disclosure is disclosed above, it should be appreciated that a computer system, as depicted in FIG. 1, is not necessary in all embodiments of the disclosure. Rather, aspects of the disclosure, including communication between groups and/or departments of a financial institution, may be embodied without the use such a computer system. For example, one or more method claims recited below do not require the technological arts of a computer system in order to be performed.

Although not required, one of ordinary skill in the art will appreciate that various aspects described herein may be embodied as a method, a data processing system, or as a computer-readable medium storing computer-executable instructions. Accordingly, those aspects may take the form of an entirely hardware embodiment, an entirely software embodiment or an embodiment combining software and hardware aspects. In addition, various signals representing data or events as described herein may be transferred between a source and a destination in the form of electromagnetic waves traveling through signal-conducting media such as metal wires, optical fibers, and/or wireless transmission media (e.g., air and/or space).

Aspects of the invention have been described in terms of illustrative embodiments thereof Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

We claim:

1. A method for providing a credit derivative, comprising:
identifying a named entity as a reference entity for the credit derivative, wherein a private debt of the named entity is a reference obligation for the credit derivative;
evaluating the credit derivative using predetermined criteria;
determining terms of an agreement for the credit derivative;
providing the agreement to a first counterparty for execution; and
recording information into at least one bookkeeping system, wherein the information corresponds to a term of the agreement after execution.

2. The method of claim 1, comprising:
determining if the agreement complies with predetermined policies and procedures; and
if the agreement does not comply, abandoning the agreement before execution.

3. The method of claim 1, comprising:
calculating a value of the credit derivative based at least on credit spread information using a mark-to-market approach.

4. The method of claim 1, wherein the predetermined criteria comprise demand and liquidity, and wherein evaluating the credit derivative using the predetermined criteria of demand comprises identifying at least one potential counterparty for the credit derivative.

5. The method of claim 1, wherein the predetermined criteria comprises spread information and liquidity.

6. The method of claim 1, wherein the predetermined criteria comprises competitor performance and liquidity.

7. The method of claim 1, wherein the terms of the agreement comprise an early termination option clause, and the method comprising:
terminating the agreement if an early termination event occurs and a protection buyer of the agreement exercises the early termination option within a predetermined time period.

8. The method of claim 7, wherein the protection buyer of the agreement may not exercise the early termination option of the agreement more than thirty days after the occurrence of the early termination event.

9. The method of claim 1, wherein the terms of the agreement after execution comprise: counterparty name, trade date, effective date, maturity date, notional value, reference entity, reference obligation, and recovery rate.

10. The method of claim 1, wherein the first counterparty is a member of a syndicate for the private debt of the named entity.

11. The method of claim 1, wherein the first counterparty is an insurance provider.

12. The method of claim 1, comprising:
providing the first counterparty with a confirmation after execution.

13. The method of claim 1, comprising:
providing the agreement to a second counterparty for execution; and
collecting a fee from the first counterparty and from the second counterparty.

14. The method of claim 1, wherein the information comprises a first information and a second information, and wherein recording the information in at least one bookkeeping system comprises:
recording the first information into a first bookkeeping system for credit default swaps; and
recording the second information into a second bookkeeping system for credit default options.

15. The method of claim 1, wherein the method is a computer-assisted method for providing a credit derivative, and wherein the at least one bookkeeping system is a computerized bookkeeping system comprising a memory for recording the information.

16. The method of claim 1, wherein the credit derivative is a credit default swap with a fixed recovery rate and a cash settlement upon the occurrence of a credit event.

17. A computer-assisted system for providing a credit derivative, comprising:
a first computer apparatus comprising a first memory and a first processor, wherein the first processor executes computer-executable instructions in the first memory for:
sending a proposal for a credit derivative, wherein the proposal identifies a named entity and a private debt of the named entity, wherein the private debt is a reference obligation for the credit derivative;
a second computer apparatus comprising a second memory and a second processor, wherein the second processor executes computer-executable instructions in the second memory for:
receiving the proposal for the credit derivative; and
sending an acceptance of the proposal after evaluating the credit derivative using predetermined criteria;
a third computer apparatus comprising a third memory and a third processor, wherein the third processor executes computer-executable instructions in the third memory for:
recording information corresponding to an executed agreement for the credit derivative.

18. The system of claim 17, wherein the first computer apparatus sends and the second computer apparatus sends and receives using electronic mail.

19. The system of claim 17, wherein the third computer apparatus records the information using at least one electronic bookkeeping system.

20. A method for providing a credit default swap on a reference obligation in a private debt market, comprising:
identifying a named reference entity with a private reference obligation for a credit default swap;
evaluating the credit default swap using predetermined criteria, wherein the predetermined criteria comprises spread information, liquidity, demand, and competitor performance;
determining terms of an agreement for the credit default swap, wherein the terms of the agreement comprise counterparty name, trade date, effective date, maturity date, notional value, reference entity, reference obligation, recovery rate, and an early termination option clause;
determining if the agreement complies with predetermined policies and procedures, and if the agreement does not comply, abandoning the agreement before execution;
providing the agreement to a first counterparty for execution;
recording first information relating to the agreement into a first bookkeeping system; and
recording second information relating to the agreement into a second bookkeeping system.
